(19) United States
(12) Patent Application Publication
(10) Pub. No.: US 2015/0076068 A1
(43) Pub. Date: Mar. 19, 2015

(54) ACTIVE INLET TEMPERATURE CONTROL FOR ADJUSTMENT OF RETENTION IN A LIQUID CHROMATOGRAPHY SYSTEM

(71) Applicant: Waters Technologies Corporation, Milford, MA (US)

(72) Inventors: Richard W. Andrews, Rehoboth, MA (US); Peyton Beals, Wrentham, MA (US); Sylvain Cormier, Mendon, MA (US)

(21) Appl. No.: 14/464,979

(22) Filed: Aug. 21, 2014

Related U.S. Application Data
(60) Provisional application No. 61/878,716, filed on Sep. 17, 2013.

(51) Int. Cl. B01D 15/16; B01D 15/18; B01D 15/42

(52) U.S. Cl. CPC B01D 15/161; B01D 15/424; B01D 15/1871
USPC 210/656; 210/198.2; 210/177

(57) ABSTRACT

Described are methods in which the retention times of a chromatographic column are adjusted through the control of the temperature of a mobile phase at the inlet to the chromatographic column. The temperature of the mobile phase at the inlet is different from the temperature of the chromatographic column. Adjustment of the temperature of the mobile phase at the inlet can be used as part of a method to transfer a chromatographic method from one liquid chromatography system to another liquid chromatography system. The method can alternatively be adapted for trapping a sample at the head of a chromatographic column to reduce the amount of band broadening of the sample from the sample injector of a liquid chromatography system. A gradient elution can then be performed to cause the concentrated volume of the analyte in the sample to elute in a tight band, resulting in improved measurement sensitivity.

### RELATED APPLICATIONS

This application claims priority to and the benefit of the filing date of U.S. Provisional Patent Application No. 61/878,716, filed on Sep. 17, 2013, the entirety of which is incorporated by reference herein.

### FIELD OF THE INVENTION

The invention relates generally to temperature control of a chromatography column in a liquid chromatography system. More particularly, the invention relates to a method for controlling retention in a chromatography column using an active column inlet preheater.

### BACKGROUND

The control of the temperature of a chromatographic column is important to the resolving efficiency of a liquid chromatography (LC) column regardless of whether the system is designed to operate isothermally or by temperature programmed analysis. Column temperature control is commonly achieved by use of a column heater.

In many LC systems the column heater is a temperature controlled chamber such as a convection oven or an oven with still air. The temperature of the fluid mixture or mobile phase provided to the column may not be constant, especially for long (e.g., multi-hour) chromatographic runs where the variations in room temperature are significant. Temperature variations can adversely impact the accuracy of the chromatographic analysis. Thus many LC systems use a device to thermally condition the mobile phase before the mobile phase passes into the column to thereby reduce column inlet fluid temperature fluctuations.

The design of the column oven is typically different for different LC systems. The particular design used is based, in part, on the requirement to achieve stable retention times and separation metrics (e.g., selectivity, peak shape and column efficiency) despite variations in the ambient temperature; however, variances in the designs can lead to differences in chromatographic results when separations of identical samples are performed on different LC systems. Moreover, due to the variety of both active and passive inlet preheating devices, the effect of solvent preheating between different column heater designs makes the transfer of methods between systems using different column heaters difficult.

### SUMMARY

In one aspect, the invention features a method for transferring a chromatographic method between liquid chromatography systems. The method includes controlling a temperature of a column thermal zone in a first liquid chromatography system based on a temperature of a column thermal zone in a second liquid chromatography system for a chromatographic method being transferred from the second liquid chromatography system to the first liquid chromatography system. The column thermal zones for the first and second liquid chromatography systems are each configured to control a temperature of a chromatographic column within the respective liquid chromatography system. The method also includes controlling a temperature of a column inlet thermal zone of the first liquid chromatography system to modify a temperature of a mobile phase passing through an inlet to the chromatographic column of the first liquid chromatography system. The temperature of the column inlet thermal zone is set to a temperature that is different from the temperature of the column thermal zone of the first liquid chromatography system. The modification of the temperature of the mobile phase changes the retention times of the chromatographic column in the first liquid chromatography system to be equivalent to the retention times of the chromatographic column in the second liquid chromatography system.

In another aspect, the invention features a liquid chromatography system that includes a column thermal zone, a chromatographic column, a column inlet thermal zone and a temperature controller. The column thermal zone is configured to control a temperature of a chromatographic column. The chromatographic column is disposed in the column thermal zone and has an inlet to receive a mobile phase. The column inlet thermal zone is configured to control the temperature of a mobile phase at the inlet of the chromatographic column. The temperature controller is in communication with the column thermal zone and the column inlet thermal zone. The temperature controller is configured to adjust a temperature of the column thermal zone to thereby control a temperature of the chromatographic column. The temperature controller is also configured to adjust a temperature of the column inlet thermal zone to thereby control the temperature of the mobile phase at the inlet of the chromatographic column such that the temperature of the mobile phase at the inlet is different from the temperature of the chromatographic column.

In yet another aspect, the invention features a method of performing liquid chromatography. The method includes injecting a sample diluent having a dissolved sample into a mobile phase. The temperature of the mobile phase at the inlet of a chromatographic column is controlled to be at a temperature that is less than a temperature of the chromatographic column to thereby increase the retention of the sample at a head of the chromatographic column. The increased retention yields an increase in a volume concentration of the sample at a head of the chromatographic column. The method further includes performing a gradient elution during which the sample retained at the head of the chromatographic column elutes from the chromatographic column.

### BRIEF DESCRIPTION OF THE DRAWINGS

The above and further advantages of this invention may be better understood by referring to the following description in conjunction with the accompanying drawings, in which like reference numerals indicate like elements and features in the various figures. For clarity, not every element may be labeled in every figure. The drawings are not necessarily to scale, emphasis instead being placed upon illustrating the principles of the invention.

FIG. 1 shows an example of van't Hoff plots for four different components for a liquid chromatography system.

FIG. 2 shows an example of how the retention times for two solutes decrease with increasing temperature.

FIG. 3 is a block diagram of a system used to control the temperature of a column in and the temperature of the mobile phase exiting a column inlet thermal zone in a liquid chromatography system.

FIG. 4 shows an example of the relationship of the retention time for the compound decanophenone for different column inlet temperatures of a mobile phase while the temperature of the column thermal zone of a liquid chromatography system is held constant.

FIG. 5 is a contour map of the temperature profile for a cross-section of a chromatographic column when the temperature of a mobile phase at the column inlet is different from the temperature of a column thermal zone.

### DETAILED DESCRIPTION

Reference in the specification to “one embodiment” or “an embodiment” means that a particular, feature, structure or characteristic described in connection with the embodiment is included in at least one embodiment of the teaching. References to a particular embodiment within the specification do not necessarily all refer to the same embodiment.

The present teaching will now be described in more detail with reference to exemplary embodiments thereof as shown in the accompanying drawings. While the present teaching is described in conjunction with various embodiments and examples, it is not intended that the present teaching be limited to such embodiments. On the contrary, the present teaching encompasses various alternatives, modifications and equivalents, as will be appreciated by those of skill in the art. Those of ordinary skill having access to the teaching herein will recognize additional implementations, modifications and embodiments, as well as other fields of use, which are within the scope of the present disclosure as described herein.

In brief overview, the invention relates to methods for adjustment of retention time of a chromatographic column by controlling the temperature of a column inlet thermal zone in which the temperature of a mobile phase at an inlet to the chromatographic column is different from the temperature of the chromatographic column.

In one embodiment, the method includes controlling a temperature of a column thermal zone in a first liquid chromatography system based on a temperature of a column thermal zone in a second liquid chromatography system for a chromatographic method being transferred from the second liquid chromatography system to the first liquid chromatography system. The column thermal zones for the first and second liquid chromatography systems are each configured to control a temperature of a chromatographic column within the respective liquid chromatography system. The method also includes controlling a temperature of a column inlet thermal zone of the first liquid chromatography system to modify a temperature of a mobile phase passing through an inlet to the chromatographic column of the first liquid chromatography system. The temperature of the column inlet thermal zone is set to a temperature that is different from the temperature of the column thermal zone of the first liquid chromatography system. The modification of the temperature of the mobile phase changes the retention times of the chromatographic column in the first liquid chromatography system to be equivalent to the retention times of the chromatographic column in the second liquid chromatography system.

In various embodiments described below, the column inlet temperature module is a column inlet pre-heater, a column inlet pre-cooler or a device capable of both heating and cooling the mobile phase before it is provided to the inlet of the chromatographic column.

A chromatographic column for LC analysis is usually in the form of a packed bed or is an open tubular column. The column contains a stationary phase, that is, a material for which the components to be separated have varying affinities. A mobile phase of the chromatographic process is generally a solvent or mixture of solvents into which the sample to be analyzed is injected. The mobile phase enters the column and the sample adsorbs onto the stationary phase. The solvent or solvent mixture is not adsorbed on the stationary phase and instead passes through the column. It should be noted that the word “column” as used herein generally means any device or component that contains the stationary phase and is not intended to limit embodiments to columns of any particular construction, number configuration, width or diameter. For example, in some embodiments the column can be formed according to a variety of geometries on a microfluidic substrate.

In some binary solvent delivery systems a first pump draws a first solvent from a tank and supplies the first solvent at a desired flow velocity and pressure to a T-shaped piping connector. A second pump draws a second solvent from a second tank and supplies the second solvent at a desired flow velocity and pressure to the T-shaped piping connector. The solvents are blended at the connector to achieve a solvent mixture having desired properties. The flow rate of each solvent can be adjusted to vary the composition of the solvent mixture over time. A variation in the solvent mixture over time is referred to as a solvent gradient or compositional gradient.

As the mobile phase passes through the column, a sample containing a mixture of different components which are typically dissolved in the mobile phase is injected. The sample components adsorb to the stationary phase to varying degrees. Components with a strong attraction to the stationary phase move more slowly through the column than components with a weak attraction. Thus the components are separated according to the different speeds of movement through the column and elute from the column at different times. The component with the least affinity for the stationary phase elutes first, while the component with the greatest affinity for the stationary phase elutes last. A detector analyzes the emerging stream by measuring a property that is related to the concentration and characteristic of chemical composition. By way of specific examples, the measured property can be the refractive index or ultra-violet absorption.

Typically chromatographic systems utilize a column heater to control column temperature. For example, the column may be located in a temperature controlled chamber such as a column oven (e.g., convection oven) or a chamber employing resistance heating. The control of column temperature is important to both component retention and the resolving efficiency of a liquid chromatography column, whether the system is designed to operate isothermally or by temperature programmed analysis. In particular, the retention time and peak shape vary in response to changes in the column temperature.

If the temperature of the mobile phase supplied to the column is not constant, for example, for long (e.g., multi-hour) chromatographic runs where the variations in room temperature are significant, the accuracy of the chromatographic analysis can degrade. A device to pre-heat the mobile phase to a steady temperature is sometimes used to reduce temperature fluctuations at the column inlet.

The role of column temperature in the control of retention times and the selectivity of separations is recognized as an important factor in performing reproducible separations. A principal aspect to performing reproducible separations is the ability to transfer a chromatographic method between different chromatographic systems. It may be desirable to transfer a method from a high-performance liquid chromatography (HPLC) system to an ultra high pressure liquid chromatography (UHPLC) system or from a UHPLC system to a HPLC system. Alternatively, it may be desirable to transfer to another chromatographic system having a different column and/or different column chemistry.

Different chromatographic systems typically incorporate column ovens of different design, in part, to ensure that retention times and separation metrics (e.g., selectivity, peak shape and column efficiency) remain stable while the ambient temperature varies. A common assumption is that the oven temperature and the average internal column temperature are the same. The characterization of a column heater (or cooler) can be performed by measuring the temperature of the column heater at a specified location with a calibrated thermometer or temperature probe; however, this technique does not accurately indicate the internal temperature of the column under chromatographic conditions. In particular, column heaters or coolers operating according to different design principles frequently exhibit different retention behavior when set to the same nominal temperature even if both column heaters provide the same temperature accuracy when measured by an external thermometer.

In UHPLC systems, the use of particles smaller than 2 μm leads to significant frictional heating as a result of the pressure-volume work done on the column. Additionally, it is important that the UHPLC column be operated in an oven which does not circulate the heating fluid (e.g., air) in order to preserve the separation efficiency. When UHPLC columns are operated in column ovens with convective circulation of air, radial thermal gradients are induced within the column. The radial thermal gradients degrade the efficiency of the separation and can lead to split peaks for single components. Because convection ovens degrade the separation efficiency of UHPLC columns, the effectiveness of devices used to pre-heat the mobile phase become significant in UHPLC. In HPLC, the absence of significant frictional heating (lower column backpressure) permits the use of convection ovens for column heating and the performance of inlet preheating is less critical to column temperature control.

The assumption that the oven set temperature and the average internal column temperature are the same is generally invalid, especially when the column ovens may differ in their operating principles and efficacy of the inlet preheater. The resulting differences in the internal column temperatures can result in differences in retention and resolution that can compromise the equivalency of test results.

The effect of column temperature on chromatographic measurements is often based on an analysis of van't Hoff plots as is known in the art. One assumption in the generation of van't Hoff plots is that the temperature which controls the partitioning of a solute between the stationary and mobile phases is the set temperature of the column oven. In chromatographic systems, the temperature varies with location within the column. At the column inlet, the primary effect on the temperature is the temperature of the incoming mobile phase which is typically heated either passively with a heat exchanger connected to the column oven or actively with a separately controlled heat exchanger. At the column outlet, the principal source of heat is based on frictional heating occurring within the column. As particle size decreases from a typical 5 μm particle in conventional HPLC to less than 2 μm in UHPLC, the significance of frictional heating associated with higher backpressures increases.

When column backpressures are low the contribution of frictional heating is less significant. Under such conditions, the mechanism of heat transfer within the column oven leads to significant differences in the effective temperature of the column. Various column ovens employ forced convection of heated or cooled air, circulating water jackets and, in some applications, are based on passive heat transfer in an oven with no active air circulation. Each design configuration typically yields linear van't Hoff plots and precise control of retention time. Moreover, each design configuration can provide an accurate temperature at a selected location within the column oven where the temperature is measured with a calibrated thermometer such as a thermocouple or thermistor. However, retention factors typically differ among column ovens especially when the design principles are not the same although identical columns and premixed mobile phases may be used.

Equation (1) is one form of the van't Hoff equation where K is the equilibrium constant for partitioning, k′ is the retention factor and θ is the phase ratio.

ln(K)=ln(k′)−ln(θ). (1)

The right side of the equation can be rewritten as follows:

ln(k′)−ln(θ)=−1/RT*ΔG° (2)

where R is the gas constant, T is the absolute temperature in Kelvin and ΔG° is the Gibbs free energy. Equations (1) and (2) can be used to derive the following relationship:

ln(k′)=−[ΔG°/R]*(1/T)+ln(θ). (3)

The van't Hoff functional relationship provided in equation (3) can be graphically represented for a particular solute as a plot of ln(k′) as a function of inverse temperature T. In general such van't Hoff plots are linear. Variations from linearity are typically associated with poor heat transfer at higher temperatures and higher flow rates, or with frictional heating at lower temperatures where a high solvent viscosity results in a significant pressure drop across the analytical column.

If the van't Hoff plots for the components of a mixture are parallel or do not intersect in the temperature range of an LC system, adjustment of the set temperature of the column oven is straightforward because the order of elution of the components does not change and relative retention metrics are typically well preserved. In that case, the temperature is incremented to ensure that the retention factor k′ is held constant for each of the critical components of the sample.

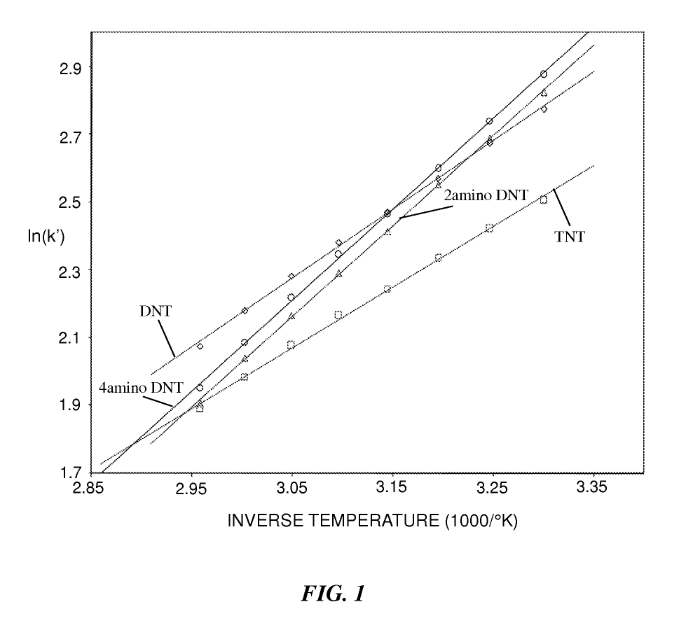

In contrast, when the van't Hoff plots intersect, the components co-elute at the temperature corresponding to the intersection point, that is, the components co-elute at an “isoretention temperature.” In addition, the order of elution reverses as the column temperature transitions through the isoretention temperature. This can result in misidentified peaks or features as well as incomplete separations of critical peak pairs. By way of an example, FIG. 1 shows van't Hoff plots for four different components for a LC system. Four isoretention temperatures are defined according to the four intersection points defined where any two of the van't Hoff plots cross.

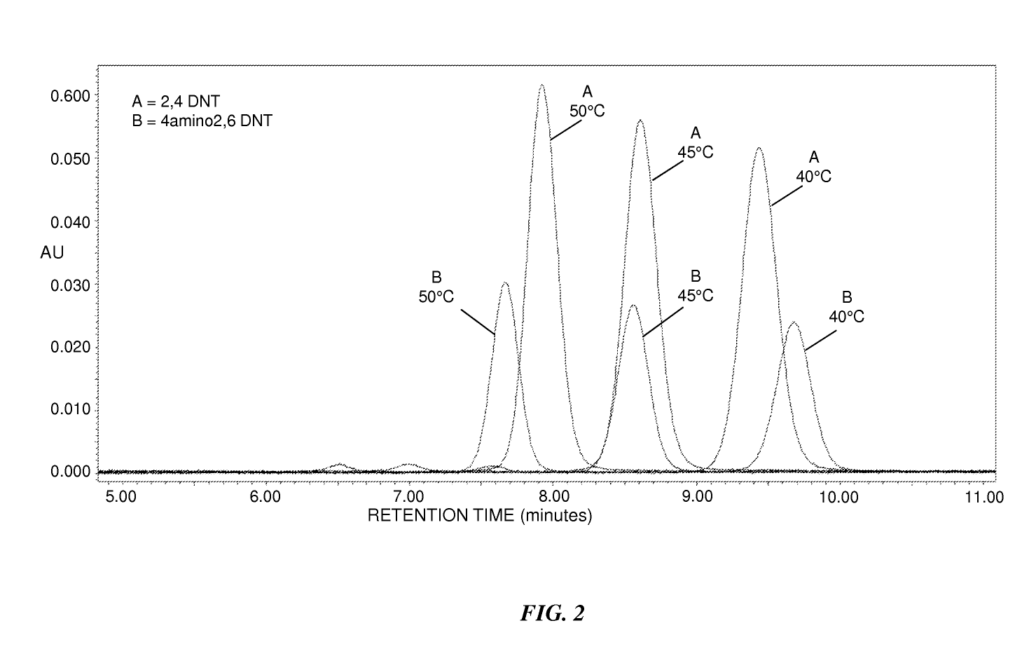

FIG. 2 shows how the retention times for two solutes A and B decrease with increasing temperature where solute A is 2,4 dinitro toluene (DNT) and solute B is 4amino2,6 DNT. Solute A elutes before solute B for temperatures less than the isoretention temperature whereas solute A elutes after solute B for temperatures greater than the isoretention temperature. The two solutes A and B co-elute when the column temperature is maintained at the isoretention temperature. The possibility of a reversal of the order of elution, or “peak order reversal”, with a change in column temperature can be problematic for unknown peaks within a chromatogram especially when the set temperature of the column is nearly equal to the isoretention temperature for the corresponding solutes.

At the intersection point of two van't Hoff plots, the separation factor α, defined as the ratio (k_{B}′/k_{A}′) of the respective retention factors, is one and the phase ratio θ is eliminated. Thus equation (3) can be expressed as

Tᵢₛₒ=[ΔH°_{B}−ΔH°_{A}]/[ΔS°_{B}−ΔS°_{A}]+φ(t) (4)

where ΔH°_{A} and ΔH°_{B} are the enthalpy changes associated with the partitioning of compounds A and B, respectively, and ΔS°_{A} and ΔS°_{B} are the entropy changes associated with the partitioning of compounds A and B, respectively. φ(t) is an error term that incorporates all of the non-equilibrium contributions to the isoretention temperature Tᵢₛₒ. Ideally, φ(t) has a small value (e.g., less than 1° C.) and does not have a strong dependence on temperature. The isoretention temperature Tᵢₛₒ is a property of the interaction of the solutes with the stationary and mobile phases and equation (4) includes the error term associated with the measurement. The isoretention temperature can be determined by plotting the two van't Hoff plots and determining the intersection point. Alternatively, the isoretention temperature can be established by determining the temperature of co-elution, that is, the temperature at which the separation factor α has a value of one. In many instances, the second approach is a more efficient and convenient approach.

If frictional heating does not contribute significantly to the internal column temperatures, separations performed for two different chromatography systems each using the same type of column, same solute pair and same mobile phase conditions can be used to relate the effective column temperatures. In particular, the difference in the isoretention temperatures is a measure of the difference in the average internal column temperatures, or effective column temperatures, for two LC systems set to the same column temperature. Methods for transferring chromatographic methods between two LC systems based on isoretention temperatures of the systems are disclosed in U.S. patent publication no. 2012/0285223 titled “Method for Determining Equivalent Thermal Conditions Between Liquid Chromatography System,” which is incorporated herein by reference. These methods are generally based on selecting an oven temperature for one LC system that is intentionally offset by the difference in the isoretention temperatures of the two LC systems for the same solute pair.

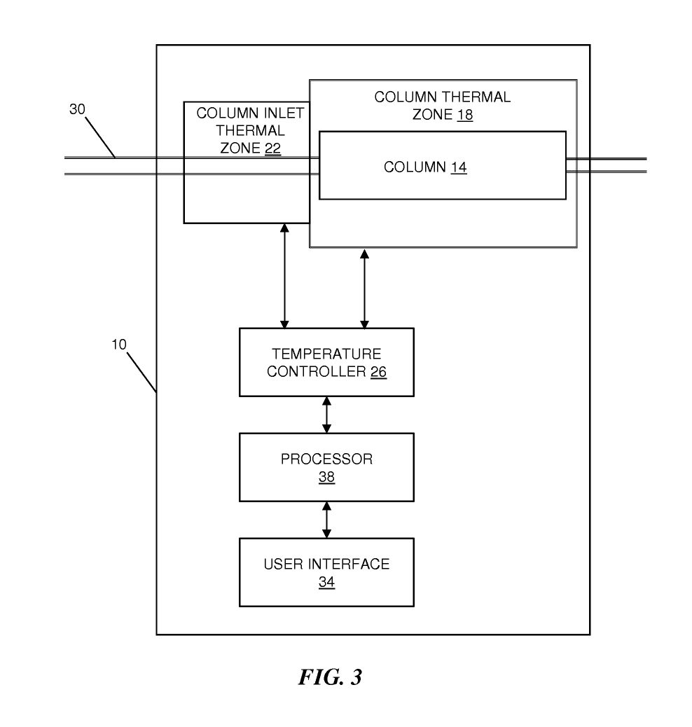

FIG. 3 is a block diagram of a system 10 that can be used to control the temperature of a column 14 in a column thermal zone 18 and the temperature of the mobile phase exiting a column inlet thermal zone 22 in a LC system. A “column thermal zone,” as used herein, means a temperature controlled region in a LC system that controls the temperature of the chromatographic column 14. A “column inlet thermal zone,” as used herein, means a thermally-controlled region or device in a LC system which receives a mobile phase and controls the temperature of the mobile phase before providing the mobile phase to the column 14 at the column inlet. In various embodiments, the column thermal zone 18 is a heater, a cooler or a module capable of heating and cooling the column 14. For example, the column thermal zone 18 can be a column oven as is known in the art. The column inlet thermal zone 22 can be a heater, a cooler or a module capable of both heating and cooling the mobile phase. For example, the column inlet thermal zone 22 can be a pre-heater and may include a thermoelectric cooler (e.g., Peltier device) to enable cooling the mobile phase to less than ambient temperature.

The system includes a temperature controller 26. Although illustrated as a single controller, the temperature controller 26 can alternatively be implemented as independent controllers, that is, as a first temperature controller to control the column thermal zone 18 and a second temperature controller to control the column inlet thermal zone 22.

The system 10 further includes a user interface 34 and a processor 38. A user provides input data that includes operational parameters for a chromatographic measurement at the user interface 34. The operational parameters input by the user are used to define and perform various embodiments of chromatographic methods as described below. The processor 38 receives the input data and provides control signals to the temperature controller 26 which in turn controls the operation of the column thermal zone 18 and the column inlet thermal zone 22. In some embodiments, the processor 38 also controls other modules and functions of an LC system.

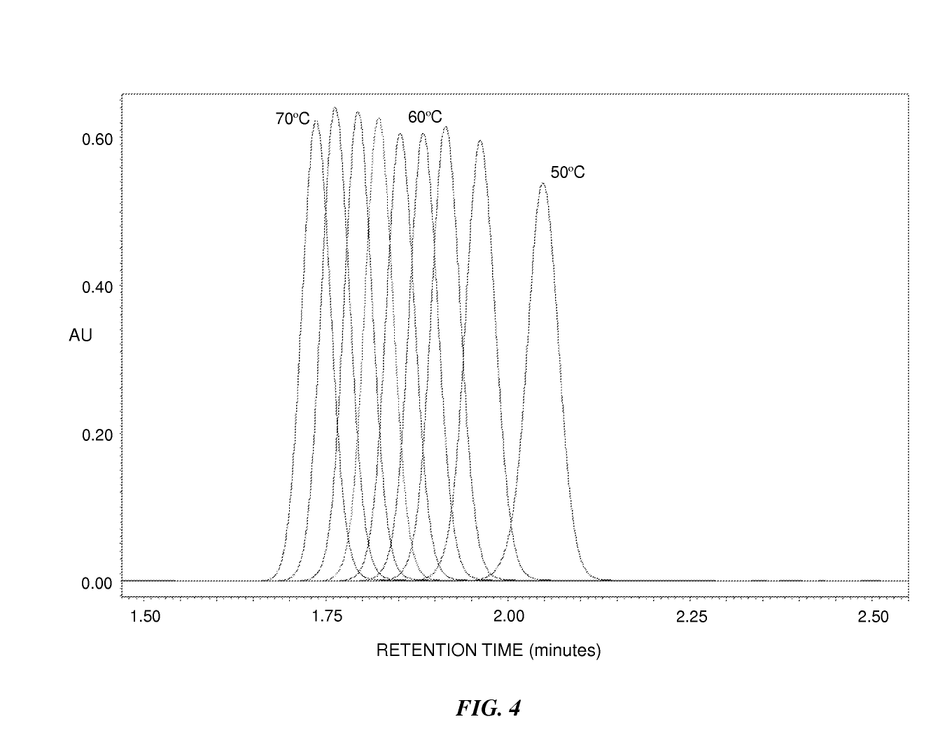

FIG. 4 shows an example of the relationship of the retention time for a compound in a mobile phase relative to the column inlet temperature of the mobile phase while the temperature of the column thermal zone is maintained at a constant value. In this example the compound is decanophenone, the column thermal zone temperature is 60° C. and the flow rate is 0.4 mL/min. The retention time is greatest at approximately 2.05 minutes when the temperature of the column inlet thermal zone is at the lowest value (50° C.). The retention time decreases monotonically with increasing temperature of the mobile phase at the column inlet. The shortest retention time occurs in less than 1.75 minutes and occurs when the temperature of the column inlet thermal zone is at the highest value (70° C.).

Although the retention time is typically controlled by adjustment of the temperature of the column thermal zone (e.g. adjustment of column oven temperature), the ability to adjust the temperature of the mobile phase at the column inlet serves as a secondary means to adjust the retention time. Thus when transferring a method from one LC system to a different LC system, adjustment of the temperature of the column inlet thermal zone can be used to fine adjust the retention time. In one embodiment, when a chromatographic method is transferred to an LC system, the temperature of the column thermal zone is set to be identical to the temperature of the column thermal zone of the original LC system and the difference in the isoretention temperatures for the two LC systems is accommodated by adjusting the mobile phase temperature at the column inlet thermal zone accordingly, for example, by setting the temperature of the column inlet thermal zone to be offset from the temperature of the column thermal zone by the difference in the isoretention temperatures. If isoretention temperatures are not available for both LC systems, the temperature of the column thermal zones are maintained at the same value and the temperature of the column inlet thermal zone is set to a value such that the retention times for the two LC systems are matched.

In FIG. 4, when the temperature of the column inlet thermal zone is less than 60° C. and therefore colder than the column thermal zone, the peaks exhibit “fronting,” that is, there is more volume defined under each plot for the time before the maximum value occurs than there is volume under the plot for time after occurrence of the maximum value. Conversely, when the temperature of the column inlet thermal zone is greater than 60° C. and therefore warmer than the temperature of the column thermal zone, the peaks exhibit “tailing,” that is, the greater volume for each plot occurs after the retention time associated with the maximum value.

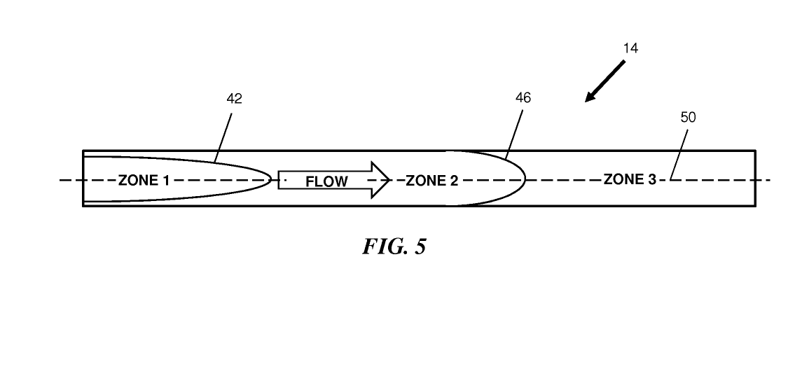

FIG. 5 is a simplified contour map of the temperature profile for a cross-section of a chromatographic column 14 when the temperature of the mobile phase at the column inlet is different from the temperature of the column thermal zone. The illustration shows three discrete thermal zones within the column 14; however, it should be recognized that the temperature varies without discontinuity within the column 14. The borders 42 and 46 defined between adjacent zones represent distinct isotherms and the temperature profile for the column includes a temperature gradient that extends along the column axis from the column inlet to the column outlet.

When the temperature of the column inlet thermal zone is set to a value that is less than the temperature of the column thermal zone, the temperature of the mobile phase increases as it passes from zone 1 to zone 2 and then to zone 3. The retention is determined primarily by the mobile phase away from the side wall of the column 14; however, the increasingly warmer mobile phase at increasing radial distances from the column axis 50 has shorter retention times which results in the peak fronting shown in FIG. 4. Conversely, when the column inlet temperature is set to a value greater than the column oven temperature, the temperature of the mobile phase decreases in the flow from zone 1 to zone 2 and then to zone 3. The increasingly colder mobile phase at increasing radial distances has greater retention times and results in the peak tailing shown in FIG. 4.

Control of the mobile phase temperature at the column inlet thermal zone to intentionally introduce peak fronting or peak tailing allows the nominal peak shape to be adjusted. For example, if a peak exhibits tailing when the temperature of the column thermal zone and the temperature of the column inlet thermal zone are set to the same temperature value, the temperature of the column inlet thermal zone can be adjusted to a lower temperature to achieve a symmetric peak shape (e.g., a gaussian peak). To achieve the same retention time as the unadjusted settings, the temperature of the column inlet thermal zone may be decreased from the initial temperature value and the temperature of the column thermal zone increased from the initial temperature value.

Advantageously, the ability to adjust the temperature of the mobile phase at the column inlet permits a sample to be focused, or trapped, at the head of the chromatographic column 14. This reduces the amount of band broadening of the sample from the sample injector of the LC system that would otherwise occur. A gradient elution can then be performed to cause the concentrated volume of the analyte to elute in a tight band. The sensitivity of the chromatographic measurement is increased due to the narrowing of the analyte band at the head of the column 14. This process of cooling the mobile phase, or heating the mobile phase to a lower temperature than the column, is particularly beneficial for applications utilizing stronger sample diluents where sample focusing at the head of the column 14 is generally more difficult to achieve. Generally, it is desirable to select the weakest sample diluent and mobile phase for keeping a sample in solution; however, this goal can make sample focusing difficult to implement. The method of relative cooling of the mobile phase at the column inlet allows for use of sample diluents and mobile phases that more readily keep the sample in solution.

While the invention has been shown and described with reference to specific embodiments, it should be understood by those skilled in the art that various changes in form and detail may be made therein without departing from the spirit and scope of the invention as recited in the accompanying claims.

What is claimed is:

1. A method for transferring a chromatographic method between liquid chromatography systems, the method comprising:
controlling a temperature of a column thermal zone in a first liquid chromatography system based on a temperature of a column thermal zone in a second liquid chromatography system for a chromatographic method being transferred from the second liquid chromatography system to the first liquid chromatography system, the column thermal zones for the first and second liquid chromatography systems each configured to control a temperature of a chromatographic column therein; and
controlling a temperature of a column inlet thermal zone of the first liquid chromatography system to modify a temperature of a mobile phase passing through an inlet to the chromatographic column of the first liquid chromatography system, wherein the temperature of the column inlet thermal zone is set to a temperature that is different from the temperature of the column thermal zone of the first liquid chromatography system, the modification of the temperature of the mobile phase changing the retention times of the chromatographic column in the first liquid chromatography system to be equivalent to the retention times of the chromatographic column in the second liquid chromatography system.

2. The method of claim 1 wherein controlling the temperature of the column thermal zone of the first liquid chromatography system comprises controlling the temperature to be substantially equal to the temperature of the column thermal zone of the second liquid chromatography system for the chromatographic method being transferred from the second chromatography system to the first chromatography system.

3. The method of claim 1 wherein controlling the temperature of the column thermal zone of the first liquid chromatography system comprises controlling the temperature according to the difference between the isoretention temperature for the first liquid chromatography system and the isoretention temperature for the second liquid chromatography system.

4. The method of claim 1 wherein the temperature of the column inlet thermal zone is controlled to adjust a peak shape in a chromatogram.

5. The method of claim 4 wherein the temperature of the column inlet thermal zone is controlled to adjust one of a peak fronting and a peak tailing of a peak in the chromatogram to thereby generate a symmetric shape for the peak.

6. A liquid chromatography system, comprising:
a column thermal zone configured to control a temperature of a chromatographic column;
a chromatographic column disposed in the column thermal zone and having an inlet to receive a mobile phase;
a column inlet thermal zone configured to control the temperature of a mobile phase at the inlet of the chromatographic column; and
a temperature controller in communication with the column thermal zone and the column inlet thermal zone, the temperature controller configured to adjust a temperature of the column thermal zone to thereby control a temperature of the chromatographic column and configured to adjust a temperature of the column inlet thermal zone to thereby control the temperature of the mobile phase at the inlet of the chromatographic column, wherein the temperature of the mobile phase at the inlet is different from the temperature of the chromatographic column.

7. The liquid chromatography system of claim 6 further comprising a user interface in communication with the temperature controller, the user interface configured to receive data for controlling the temperature of the column thermal zone and controlling the temperature of the column inlet thermal zone.

8. The liquid chromatography system of claim 7 further comprising a processor in communication with the user interface and the temperature controller, the processor configured to receive data from the user interface and to provide control signals to the temperature controller for control of the temperature of the column thermal zone and the temperature of the column inlet thermal zone.

9. The liquid chromatography system of claim 6 wherein the column thermal zone comprises a column heater.

10. The liquid chromatography system of claim 6 wherein the column inlet thermal zone comprises a pre-heater configured to increase the temperature of the mobile phase at the inlet to greater than an ambient temperature.

11. The liquid chromatography system of claim 6 wherein the column inlet thermal zone comprises a cooler to reduce the temperature of the mobile phase at the inlet to less than an ambient temperature.

12. The liquid chromatography system of claim 6 wherein the column inlet thermal zone comprises a heater and a cooler.

13. The liquid chromatography system of claim 11 wherein the cooler comprises a Peltier device.

14. A method of performing liquid chromatography, the method comprising:
injecting a sample diluent having a sample dissolved therein into a mobile phase;
controlling a temperature of the mobile phase at the inlet of a chromatographic column to be at a temperature that is less than a temperature of the chromatographic column to thereby increase a retention of the sample at a head of the chromatographic column, wherein the increased retention yields an increase in a volume concentration of the sample at a head of the chromatographic column; and
performing a gradient elution during which the sample retained at the head of the chromatographic column elutes from the chromatographic column.

15. The method of claim 14 wherein the mobile phase at the inlet of the chromatographic column is cooled to a temperature that is less than an ambient temperature.
